(19) United States
(12) Patent Application Publication
(10) Pub. No.: US 2026/0153698 A1
(43) Pub. Date: Jun. 4, 2026

(54) MULTI-CHIPLET OPTICAL MATRIX COMPUTING ARCHITECTURE

(71) Applicant: HUAZHONG UNIVERSITY OF SCIENCE AND TECHNOLOGY, Hubei (CN)

(72) Inventors: Jian WANG, Hubei (CN); Xu dong Liu, Hubei (CN); Yuanjian Wan, Hubei (CN); Yu Zhang, Hubei (CN)

(73) Assignee: HUAZHONG UNIVERSITY OF SCIENCE AND TECHNOLOGY, Hubei (CN)

(21) Appl. No.: 19/392,067

(22) Filed: Nov. 17, 2025

(30) Foreign Application Priority Data
Nov. 29, 2024 (CN) 202411738741.X

(51) Int. Cl. G02B 6/43

(52) U.S. Cl. CPC G02B 6/43

(57) ABSTRACT

A multi-chiplet optical matrix computing architecture is provided. Matrix blocking is adopted to decompose a large-scale optical matrix computing chip into several small-scale optical matrix computing chiplets. Separation of active and passive modules is adopted to decompose the optical matrix computing chip. The M×N matrix A is decomposed into m×n p×q matrices Aᵢⱼ. An input N-dimensional vector X is decomposed into n channel q-dimensional vectors Xⱼ, and an output M-dimensional vector Y is decomposed into m p-dimensional vectors Yᵢ. Input light passes through n modulator array chiplets to form n channel q-dimensional vectors. After m times of beam splitting and replication, m×n q-dimensional vectors are formed, input into the m×n optical matrix computing chiplets, and multiplied with Aᵢⱼ to obtain m×n p-dimensional vectors. After the light of n channels passes through n-channel multiplexing, m p-dimensional vectors are obtained and then detected. Large-scale matrix-vector multiplication computation Y=AX is thus implemented.

### CROSS-REFERENCE TO RELATED APPLICATION

This application claims the priority benefit of China application serial no. 202411738741.X, filed on Nov. 29, 2024. The entirety of the above-mentioned patent application is hereby incorporated by reference herein and made a part of this specification.

### BACKGROUND

### Technical Field

The disclosure belongs to the field of optical computing, more specifically, relates to a multi-chiplet optical matrix computing architecture.

### Description of Related Art

From big data, cloud computing to artificial intelligence, new generation information technology has led the rapid development of the intelligent era. Large-scale, high computing power, and low energy consumption are important trends in intelligent computing. However, as Moore's Law approaches its limits, problems such as chip power consumption and heat dissipation are becoming increasingly serious, and the development of large-scale integrated chips and further improvement of chip computing efficiency are thus severely limited. To solve this problem, optical computing uses light waves as carriers for information processing, with advantages such as multi-dimensionality, large bandwidth, low latency, and low power consumption. As such, matrix computing is accelerated, and a new computing architecture of “transmission as computation and structure as function is provided. With the continuous development of artificial intelligence, the demand for optical computing is also continuously increasing, and an important trend toward high integration is presented. In recent years, optical computing chips have received much attention due to their advantages of combining optical matrix computation and integrated chips. At present, optical matrix computing acceleration chips may be roughly divided into four technical routes: matrix computing based on two-dimensional planar diffraction structures, matrix computing based on cascaded Mach-Zehnder interferometers, matrix computing based on micro-ring resonators and wavelength division multiplexing, and matrix computing based on phase-change material synaptic arrays. Herein, the matrix computing based on two-dimensional planar diffraction structures, although extremely low in power consumption, lacks reconfigurability and has high requirements for micro-nano processing technology. The matrix computing based on phase-change material synapse arrays has a relatively low number of switching times, with the problem of later failure. While the matrix computing based on wavelength division multiplexing has poor stability due to the high sensitivity of working wavelengths of the micro-ring resonators to temperature and environment. In comparison, the technical solution based on the cascaded Mach-Zehnder has strong reconfigurability and stable operation, making it more suitable for large-scale integration. Therefore, at present, the technical solution based on the cascaded Mach-Zehnder is adopted by companies such as Lightmatter and Lightelligence most of the time.

However, no matter which of the above integrated optical matrix computing implementation methods is used, there exists a problem of difficulty in supporting large-scale matrix computing. Due to the relatively large size of integrated optical devices, the matrix scale that a single chip can support is far smaller than micro-electronic chips, thus making it difficult to support more complex neural network algorithms. Further, the classification tasks implemented are limited to simple datasets such as MNIST. In recent years, with the improvement of chip process technology, yield, complexity, and the emergence of chiplets and advanced packaging technology, conducting research on large-scale optical matrix multi-chiplet accelerated computation has important value for promoting the further development of artificial intelligence and high-performance computing technology. Chiplets, also called small chip sets, decompose large chips according to computational or functional units, select appropriate different process technologies according to their characteristics, combine with interlayer, and then interconnect and assemble various functional small chips through advanced packaging technology. Similar to building Lego blocks, chiplets have the advantages of strong scalability, high yield, low complexity, and low cost, and they are of great significance for building ultra-large-scale photonic integrated chip systems for complex tasks.

### SUMMARY

For the defects of the computing architecture of the related art, the disclosure aims to provide a multi-chiplet optical matrix computing architecture based on matrix blocking and aims to solve the problem of limited scale of an optical matrix computing chip.

To achieve the above, the disclosure provides a multi-chiplet optical matrix computing architecture decomposing a large chip into a plurality of small chiplets through matrix blocking and separation of active modules and passive modules on an optical computing architecture and specifically including n modulator array chiplets, m×n optical matrix computing chiplets, m detector array chiplets, and an optical transfer plate for chiplet interconnection. The matrix blocking decomposes the large chip into arrays and matrices according to a functional scale and a manufacturing process. The active modules include the modulator array chiplets and the detector array chiplets, and the passive modules include the optical matrix computing chiplets. Each modulator array chiplet includes q parallel modulators, each detector array chiplet includes p parallel detectors, and each optical matrix computing chiplet provides a p×q matrix computing sub-function including q input ports and p output ports. Input light passes through the n modulator array chiplets, is modulated into q-path signal light in each modulator array chiplet, and forms n channel q-dimensional input vectors Xⱼ after passing through the n modulator array chiplets. Each channel q-dimensional input vector Xⱼ is replicated m times through l:m beam splitting. The n channel q-dimensional input vectors Xⱼ form m×n q-dimensional vectors after replication and are correspondingly input into the m×n optical matrix computing chiplets separately and multiplied with corresponding p×q matrices Aᵢⱼ to obtain m×n p-dimensional vectors. Light from n channels is multiplexed through n-channel multiplexing, and m p-dimensional output vectors Yᵢ are obtained and provided to the m detector array chiplets for sequential detection to obtain a multi-chiplet optical matrix computing result. The light from the n channels includes orthogonal channels of different wavelengths, orthogonal channels of different polarizations, orthogonal channels of different modes, orthogonal channels of other optical wave dimensions, and orthogonal channels of different dimensional combinations, where i=1, 2, . . . , and m, and j=1, 2, . . . , and n. The architecture aims to solve the accelerated computation of M×N extra-large-scale matrix A multiplied by N-dimensional vector X. The optical computing architectures of the related art are implemented by directly constructing computation chips corresponding to M×N matrices, while in the disclosure, for large-scale matrix-vector multiplication computation Y=AX (X is the input N-dimensional vector, Y is the output N-dimensional vector, and A is an M×N matrix), the idea of block matrix is adopted, and m×n p×q (M=m×p and N=n×q) optical matrix computing chiplets Aᵢⱼ (i=1, 2, . . . , and m and j=1, 2, . . . , and n) are used to form an extra-large-scale M×N matrix A, and then the N-dimensional vector X is decomposed into n q-dimensional vectors Xᵢ (i=1, 2, . . . , and n). The specific decomposition method is shown in formulas (1) and (2):

$$A = ( \begin{matrix}{a}_{1 , 1} & {a}_{1 , 2} & … & {a}_{1 , q} & … & {a}_{1 , N} \\ {a}_{2 , 1} & {a}_{2 , 2} & … & {a}_{2 , q} & … & {a}_{2 , N} \\ ⋮ & ⋮ & ⋱ & ⋮ & ⋱ & ⋮ \\ {a}_{p , 1} & {a}_{p , 2} & … & {a}_{p , q} & … & {a}_{p , N} \\ ⋮ & ⋮ & ⋱ & ⋮ & ⋱ & ⋮ \\ {a}_{M , 1} & {a}_{M , 2} & … & {a}_{M , q} & … & {a}_{M , N}\end{matrix} ) = ( \begin{matrix}\begin{matrix}{a}_{1 , 1} & {a}_{1 , 2} & … & {a}_{1 , q} \\ {a}_{2 , 1} & {a}_{2 , 2} & … & {a}_{2 , q} \\ ⋮ & ⋮ & ⋱ & ⋮ \\ {a}_{p , 1} & {a}_{p , 2} & … & {a}_{p , q}\end{matrix} & \begin{matrix}{a}_{1 , q + 1} & {a}_{1 , q + 2} & … & {a}_{1 , 2 q} \\ {a}_{2 , q + 1} & {a}_{2 , q + 2} & … & {a}_{2 , q + q} \\ ⋮ & ⋮ & ⋱ & ⋮ \\ {a}_{p , q + 1} & {a}_{p , q + 2} & … & {a}_{p , q + q}\end{matrix} & … \\ \begin{matrix}{a}_{p + 1 , 1} & {a}_{p + 1 , 2} & … & {a}_{p + 1 , q} \\ {a}_{p + 2 , 1} & {a}_{p + 2 , 2} & … & {a}_{p + 2 , q} \\ ⋮ & ⋮ & ⋱ & ⋮ \\ {a}_{2 p , 1} & {a}_{2 p , 2} & … & {a}_{2 p , q}\end{matrix} & ⋱ & ⋮ \\ ⋮ & … & \begin{matrix}{a}_{M - p + 1 , N - p + 1} & {a}_{M - p + 1 , N - p + 2} & … & {a}_{M - p + 1 , N} \\ {a}_{M - p + 2 , N - p + 1} & {a}_{M - p + 2 , N - p + 2} & … & {a}_{M - p + 2 , N} \\ ⋮ & ⋮ & ⋱ & ⋮ \\ {a}_{M , N - p + 1} & {a}_{M , N - p + 2} & … & {a}_{M , N}\end{matrix}\end{matrix} ) = ( \begin{matrix}{A}_{11} & {A}_{12} & … & {A}_{1 n} \\ {A}_{21} & {A}_{22} & … & {A}_{2 n} \\ ⋮ & ⋮ & O & ⋮ \\ {A}_{m 1} & {A}_{m 2} & … & {A}_{mn}\end{matrix} ) and \qquad ( 1 )$$

$$X = {( {x}_{1} , {x}_{2} , … , {x}_{q} , … , {x}_{N - q + 1} , {x}_{N - q + 2} , … , {x}_{N} )}^{T} = {( {X}_{1} , {X}_{2} , … {X}_{n} )}^{T} . \qquad ( 2 )$$

Each vector Xᵢ is loaded through a modulator matrix chiplet, each modulator matrix chiplet corresponds to one channel, and each port of the modulator matrix corresponds to one element of the vector. A modulated optical signal is coupled into the optical transfer plate, then divided into m paths through a beam splitter, and input into m optical matrix computing chiplets. Each chiplet includes q input ports, corresponding one-to-one with the q output ports of the modulator. A multi-layer transfer plate can well separate two-path optical signals, and a large number of waveguide crossings are thus avoided. Take light of a first wavelength, which is coupled into an optical matrix computing chiplet A₁₁ after beam splitting, as an example, the light intensity of the p output ports of the optical matrix computing chiplet A₁₁ forms the vector Y₁₁=A₁₁X₁. Light intensity of a second wavelength coupled into the p output ports of a chiplet A₁₂ forms a vector Y₁₂=A₁₂X₂. Similarly, the light intensity of the n^{th} wavelength coupled into the p output ports of the chiplet Ain forms a vector Yᵢₙ=AₗₙXₙ. Y₁₁, Y₁₂, . . . , and Yᵢₙ are coupled into the optical transfer plate and re-routed, the j^{th} (j=1, 2, . . . , and p) channel of each group of optical signal arrays is re-routed together, and channel multiplexing is implemented through a multiplexer and finally received by the detector array chiplets. This process completes the addition of corresponding elements of the vector groups Y₁, Y₁₂, . . . , and Yᵢₙ, which is equivalent to adding Y₁₁, Y₁₂, . . . , and Yᵢₙ, and a k-dimensional vector Y₁=AₙX₁+A₁₂X₂+ . . . +AₗₙXₙ is obtained. Note that the entire architecture includes m detector array chiplets, each obtaining k-dimensional vectors Y₁, Y₂, . . . , and Yₘ together form the final M-dimensional vector, which is the output vector of the entire multi-chiplet acceleration system. The computation process is shown in FIG. 2, where X and Y are the input and output vectors, A is the target matrix, Xⱼ represents the input vector of the j^{th} modulator array chip, Yᵢ represents the vector received by the i^{th} detector array chip, satisfying the relationship Y=(Yᵢ, Y₂, . . . , Yₘ)^{T} and X=(X₁, X₂, . . . , Xₙ)^{T}.

Preferably, each of the modulator array chiplets includes q parallel modulators. The modulators include micro-ring modulators, micro-disk modulators, photonic crystal micro-cavity modulators, Mach-Zehnder modulators, electro-absorption modulators, modulators based on two-dimensional materials, or micro-ring and Mach-Zehnder combination structure modulators.

Preferably, each of the detector array chiplets includes p parallel detectors. The detectors include germanium-silicon photodetectors, avalanche detectors, III-V group-based photodetectors, or detectors based on two-dimensional materials.

Preferably, the architecture of optical matrix computing chiplets include cascaded Mach-Zehnder interferometers, micro-ring resonator arrays, phase-change material synapse arrays, or on-chip two-dimensional planar diffraction structures. A network type adopted by the cascaded Mach-Zehnder interferometers is a triangular network, a rectangular network, or a non-universal Fast Fourier Transform (FFT) network.

Preferably, the optical transfer plate includes a single-layer structure or a multi-layer structure, each layer includes a waveguide array, an interlayer coupler, a l:m beam splitter, an n-channel multiplexer, etc., and a multi-layer waveguide is adopted to reduce waveguide crossing of chiplet interconnection. The interlayer coupler uses an evanescent wave coupler to implement coupling between a chiplet layer and an optical transfer plate layer and coupling between different optical transfer plate layers. The l:m beam splitter uses a multi-mode interference coupler or other micro-nano structure beam splitters for routing the signal light to each optical matrix computing chiplet. The n-channel multiplexer is used to multiplex and add computation results from each optical matrix computing chiplet and includes but not limited to a wavelength division multiplexer, a polarization multiplexer, a mode multiplexer, and can also be a multi-physical and multi-dimensional multiplexer of light waves integrating wavelength, polarization, and mode.

Preferably, the input light enters the n modulator array chiplets or the optical transfer plate through coupling, and a coupling method is end-surface coupling or vertical coupling, etc.

Preferably, a material platform of the modulator array chiplets is silicon, thin-film lithium niobate, electro-optic polymers, III-V group, two-dimensional materials, ferroelectric thin films, piezoelectric thin films, etc. A material platform of the optical matrix computing chiplets is silicon, silicon nitride, silicon dioxide, and thin-film lithium niobate. A material platform of the detector array chiplets is germanium epitaxially grown on silicon, III-V group, and two-dimensional materials. A material platform of the optical transfer plate is silicon nitride, silicon dioxide, organic polymer materials, etc.

Preferably, a peripheral circuit module for driving and controlling a multi-chiplet system. The peripheral circuit module includes a high-speed signal loading circuit and a low-speed multi-channel control power source. The high-speed signal loading circuit includes a high-speed field programmable gate array (FPGA), a high-speed digital-to-analog converter (DAC), a high-speed analog-to-digital converter (ADC), a high-speed driver amplifier (Driver), a high-speed trans-impedance amplifier (TIA), etc. The high-speed FPGA is used to provide a digital electrical signal corresponding to data to be computed and processed. Through the high-speed DAC, an analog electrical signal is obtained and is then driven and loaded to the modulator after being amplified to an appropriate level by the high-speed Driver. After optical matrix computing, a detected electrical signal is obtained through the detector and is appropriately amplified together with the high-speed TIA. A digital electrical signal is obtained through the high-speed ADC and is finally provided to the high-speed FPGA or a computer for processing. the low-speed multi-channel control power source includes a microprocessor (e.g., a single-chip microcomputer) or a low-speed FPGA, a low-speed multi-channel DAC, a low-speed power amplifier, etc. and is used to control and adjust various phase shifters in optical chips and chiplets, so as to flexibly configure coefficients in a matrix of optical matrix computing.

Preferably, the modulator array chiplets, the detector array chiplets, the optical matrix computing chiplets, and the optical transfer plate are integrated through a direct bonding method. A packaging method between the peripheral circuit modules and the optical transfer plate is 2.5D or 3D advanced packaging. 2.5D packaging is implemented by wire bonding an electronic chip and the optical transfer plate on a ceramic transfer plate or a printed circuit board (PCB), or 3D advanced packaging is implemented by directly flip-chip bonding the electronic chip combined with through-silicon via technology, etc.

The above technical solutions provided by the disclosure have the following beneficial effects compared with the related art.

1. The disclosure provides a multi-chiplet optical matrix computing architecture. The technical challenges of high design and manufacturing difficulty, low yield, and high costs of extra-large-scale optical matrix computing chips are addressed. Multiple small-scale matrix computing chiplets are used to construct a large-scale matrix computation system, so a new approach for implementing extra-large-scale optical matrix computation is provided.

2. In the disclosure, by taking advantages of the chiplets being small in volume and may be freely combined, matrix computation systems of various scales can be constructed through the same optical matrix computing chiplet units, high flexibility is thus provided.

3. In the disclosure, the multi-chiplet interconnection method exhibits universal applicability, so it is suitable for optical matrix computation acceleration and can also be applied to other application scenarios.

### BRIEF DESCRIPTION OF THE DRAWINGS

FIG. 1 is a schematic diagram of a multi-chiplet optical matrix computing architecture.

FIG. 2 is a schematic diagram of matrix decomposition and a computation principle of the multi-chiplet optical matrix computing architecture.

FIG. 3 is a schematic diagram of a multi-chiplet optical matrix computing architecture prototype system, including n modulator array chiplets, m detector array chiplets, m×n optical matrix computing chiplets, and an optical transfer plate for multi-chiplet interconnection.

FIG. 4 is a schematic diagram of a specific example system structure of the multi-chiplet optical matrix computing architecture.

FIG. 5 is a schematic diagram of a chiplet connection method for the multi-chiplet optical matrix computing architecture.

FIG. 6 is a structural schematic diagram and comparison of representation capabilities of arbitrary unitary matrices between a general architecture (including a triangular network and a rectangular network) in a cascaded Mach-Zehnder optical matrix computing architecture and a fast Fourier transform (FFT) network architecture.

FIG. 7 is a schematic diagram of an optical transfer plate structure.

FIG. 8 is a schematic diagram of structures and principles of a silicon-silicon nitride interlayer coupler and a wavelength division multiplexer on a silicon nitride transfer plate.

FIG. 9 is a schematic diagram of a packaging method for optical chiplets, electronic chips, and the optical transfer plate.

FIG. 10 is a schematic diagram of an optical chiplet bonding solution and an interconnection solution between the electronic chip and the optical transfer plate.

### DESCRIPTION OF THE EMBODIMENTS

In order to make the objectives, technical solutions, and advantages of the disclosure clearer and more comprehensible, the disclosure is further described in detail with reference to the drawings and embodiments. It should be understood that the specific embodiments described herein serve to explain the disclosure merely and are not used to limit the disclosure. In addition, the technical features involved in the various embodiments of the disclosure described below can be combined with each other as long as the technical features do not conflict with each other.

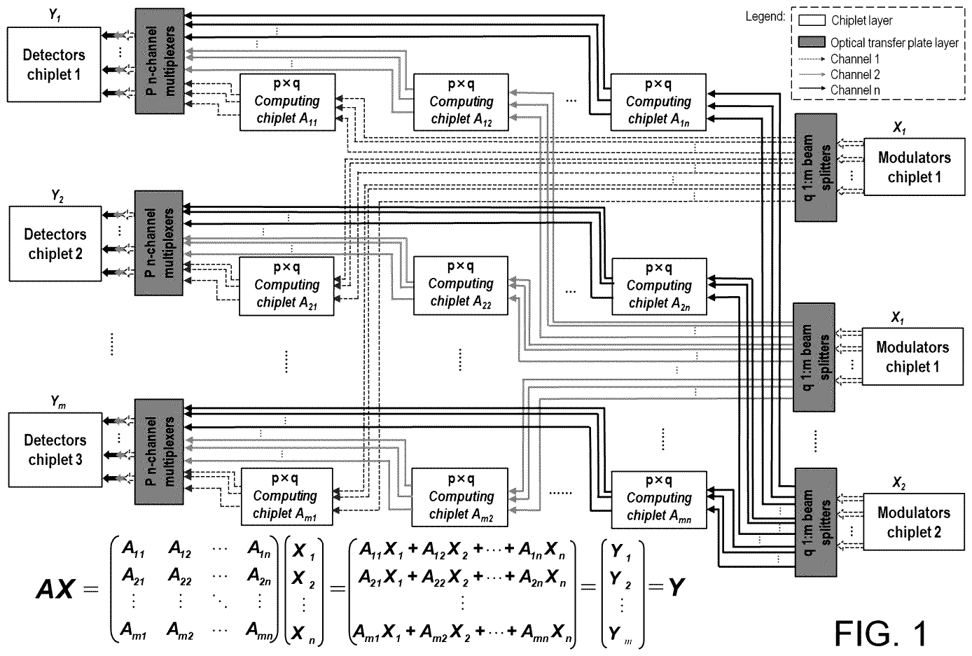

For the problem of limited scale of the optical matrix computing chips at the current stage, the disclosure provides a scalable multi-chiplet optical matrix computing architecture. The disclosure aims to implement large-scale optical matrix acceleration computation through multi-chiplet combination, achieve flexible switching of optical matrices of different scales by changing the number of chiplets, and implement interconnection between multiple chiplets using an optical transfer plate. As shown in FIG. 1, the disclosure specifically includes n modulator array chiplets, m×n optical matrix computing chiplets, m detector array chiplets, and an optical transfer plate for chiplet interconnection. Matrix blocking decomposes a large chip into arrays and matrices according to a functional scale and a manufacturing process. Active modules include the modulator array chiplets and the detector array chiplets, and passive modules include the optical matrix computing chiplets. Each modulator array chiplet includes q parallel modulators, each detector array chiplet includes p parallel detectors, and each optical matrix computing chiplet provides a p×q matrix computing sub-function including q input ports and p output ports. Input light passes through the n modulator array chiplets, is modulated into q-path signal light in each modulator array chiplet, and forms n channel q-dimensional input vectors Xⱼ after passing through the n modulator array chiplets. Each channel q-dimensional input vector Xⱼ is replicated m times through l:m beam splitting. The n channel q-dimensional input vectors Xⱼ form m×n q-dimensional vectors after replication and are correspondingly input into the m×n optical matrix computing chiplets separately and multiplied with corresponding p×q matrices Aᵢⱼ to obtain m×n p-dimensional vectors. Light from n channels is multiplexed through n-channel multiplexing, and m p-dimensional output vectors Yᵢ are obtained and provided to the m detector array chiplets for sequential detection to obtain a multi-chiplet optical matrix computing result. The light from the n channels includes orthogonal channels of different wavelengths, orthogonal channels of different polarizations, orthogonal channels of different modes, orthogonal channels of other optical wave dimensions, and orthogonal channels of different dimensional combinations, where i=1, 2, . . . , and m, and j=1, 2, . . . , and n.

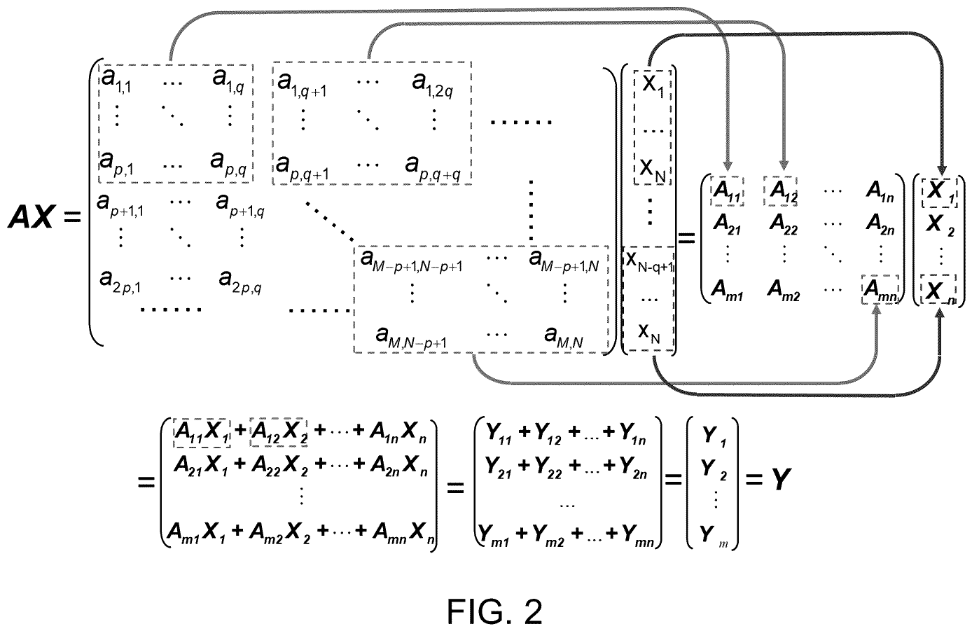

As shown in FIG. 2, which is a schematic diagram of matrix decomposition and a computation principle of the multi-chiplet optical matrix computing architecture. The specific computation principle is described in detail in the summary section.

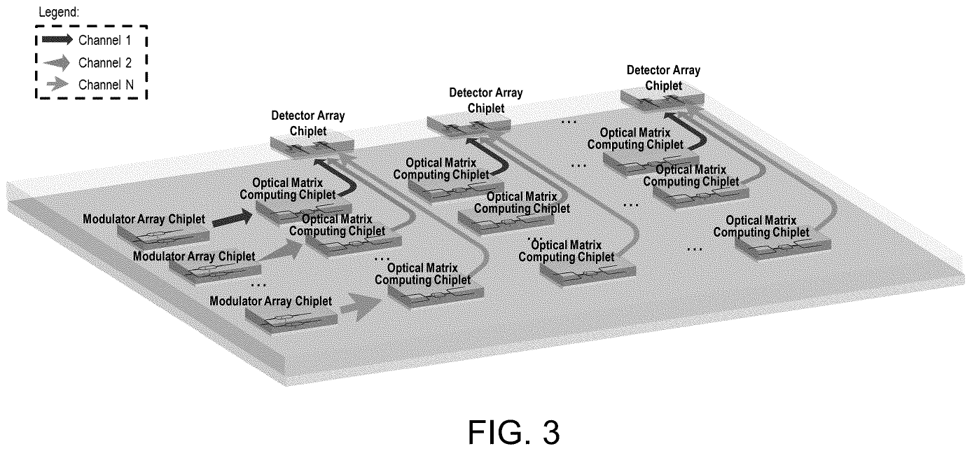

As shown in FIG. 3, in the embodiments of the disclosure, a multi-chiplet optical matrix computing architecture and a system structure include n modulator array chiplets, m detector array chiplets, four optical matrix computing chiplets, and an optical transfer plate for multi-chiplet interconnection. Preferably, wavelength division multiplexing is selected as different channels. To be specific, a light source uses m light of different wavelengths, which are individually coupled into the optical transfer plate, divided into q paths, and then coupled into the modulator array chiplets. The modulator array chiplets are a q-path modulator array, and the n modulator array chiplets are used to load n q-dimensional vectors, which together combine to form an N (N=n×q)-dimensional input vector. The N modulated optical signals are divided into m signals through a multi-layer optical transfer plate and input into the m optical matrix computing chiplets. An output result of each optical matrix computing chiplet is p paths of light with different light intensities, forming a p-dimensional vector. Next, through wavelength division multiplexer devices on a silicon nitride transfer plate, multiplexing is implemented, and finally, m p-path detector array chiplets receive and complete the addition to obtain an M (N=m×p)-dimensional vector output.

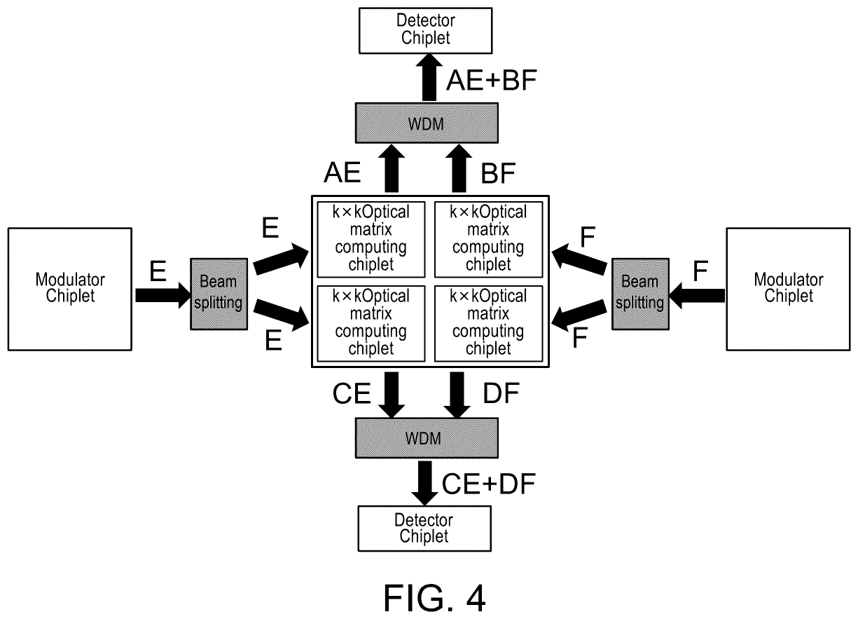

As shown in FIG. 4, in the embodiments of the disclosure, a specific multi-chiplet optical matrix computing system includes two modulator array chiplets, two detector array chiplets, the optical transfer plate, and four k×k optical matrix computing chiplets A, B, C, and D used to form a 2k×2k large-scale optical matrix computing system. The light source uses two light of different wavelengths, which are individually coupled into the optical transfer plate, divided into k paths, and then coupled into the modulator array chiplets. The modulator array chiplets are a k-path modulator array. The input 2k-dimensional vector is decomposed into two k-dimensional vectors E and F loaded by the two modulator array chiplets. The k-path modulated optical signals are split into two through a multi-layer silicon nitride transfer plate and input into two chiplets. Calculation results AE (CE) and BF (DF) are multiplexed through a wavelength division multiplexer and finally enter the detectors to complete addition. Two k-dimensional vectors AE+BF and CE+DF are obtained, which together form the final 2k-dimensional vector.

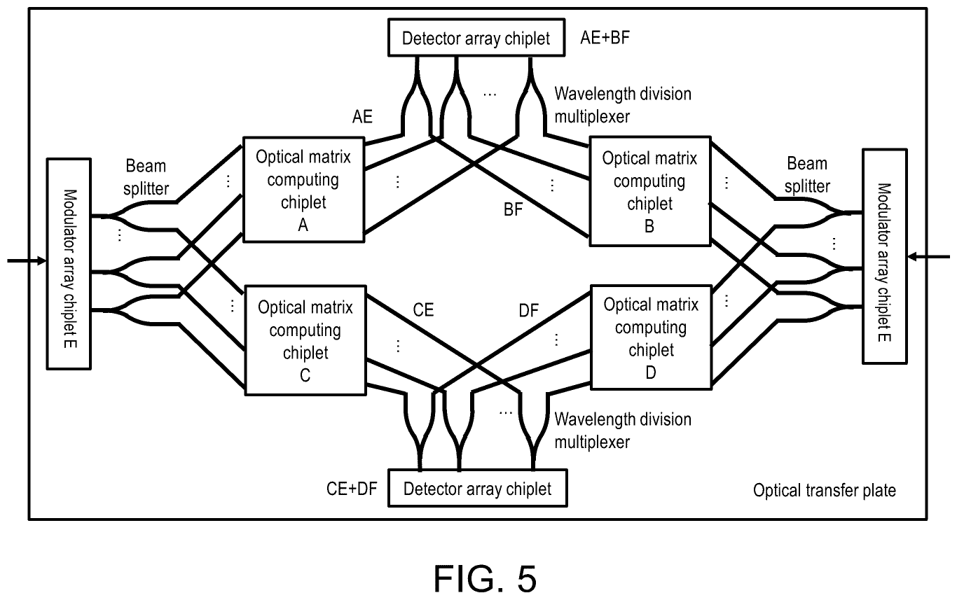

As shown in FIG. 5, in the embodiments of the disclosure, the multi-chiplet interconnection uses a double-layer waveguide crossing structure. The optical transfer plate uses a double-layer waveguide structure, where black represents an upper layer silicon nitride waveguide, and red represents a lower layer silicon nitride waveguide. The light intensity of the k-path light passing through the two modulator matrix chiplets is represented by vectors E and F and then coupled into a lower waveguide and complete beam splitting. After splitting, one branch is coupled to an upper waveguide, and one branch is coupled to the lower waveguide, and the two are routed to two optical computing chips A and C (B and D). Similarly, the output light AE and BF (CE and DF) from two computing chips A and B (C and D) also travel through the upper and lower waveguides to recombine and couple to the lower waveguide again. AE (CE) and BF (DF) are multiplexed through the wavelength division multiplexer on the lower waveguide and finally enter the k-path detector matrix chiplets to complete the addition.

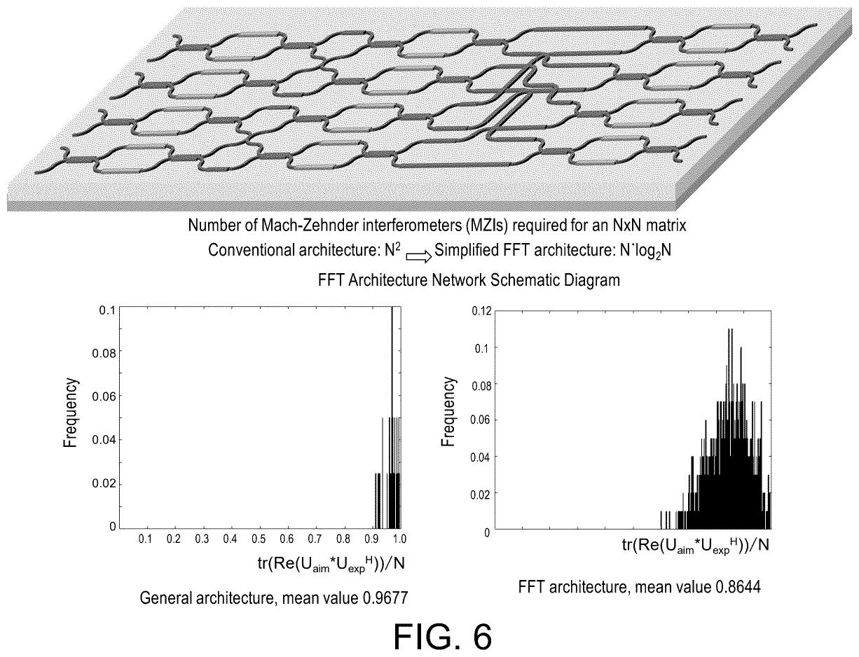

As shown in FIG. 6, in the embodiments of the disclosure, matrix representation functions of different computing architectures for the optical matrix computing chiplets are compared. In a fast Fourier transform architecture network (FFTNet), the number of units required by a k×k cascaded Mach-Zehnder interferometer network architecture is reduced from k² to log 2k, and the comparison of the two structures is shown in the figure. Compared with a conventional triangular network and a rectangular network, optical path loss and optical phase accumulation errors are effectively reduced, input light source power requirements are lowered, the number of units and the number of phase shifter drivers are decreased, the contradiction between matrix versatility and complexity is balanced, and large-scale optical matrix computation is implemented. Meanwhile, an error function tr(Re(Uₐᵢₘ*Uₑₓₚ^{H}))/k is defined to measure the similarity between a transmission matrix Uₑₓₚ of the FFT architecture and a target matrix Uₐᵢₘ, where Uₐᵢₘ is a randomly-generated unitary matrix. The comparison between the FFT architecture and the general matrix architecture is shown in the figure, where the closer tr(Re(Uₐᵢₘ*Uₑₓₚ^{H}))/is to 1, the smaller the difference between the transmission matrix and the target matrix. For a unitary matrix, when Uₑₓₚ=Uₐᵢₘ, Uₐᵢₘ*Uₑₓₚ^{H}=I (unit matrix), that is, tr(Re(Uₐᵢₘ*Uₑₓₚ^{H}))/k=tr(I)/k=1. The selection of specific matrix architecture may be freely modulated according to the research problem, and the proposed multi-chiplet optical matrix computing acceleration architecture is compatible with various matrix computing implementation methods.

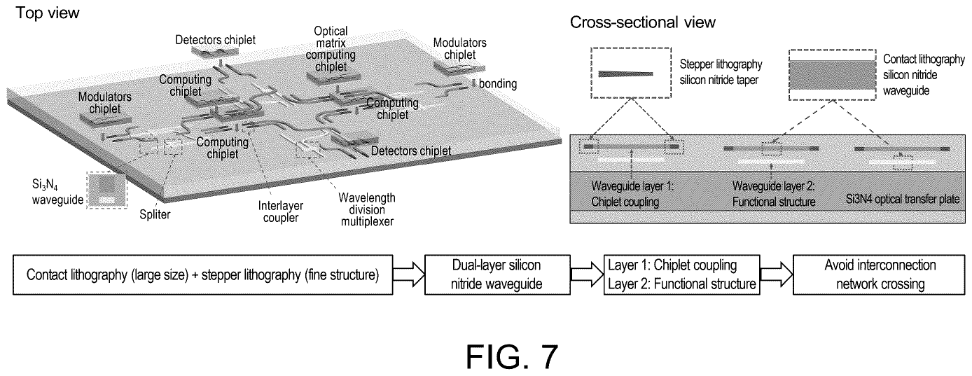

As shown in FIG. 7, in the embodiments of the disclosure, a silicon nitride optical transfer plate includes a plurality of interlayer couplers, k 1:2 beam splitters, and k dual-wavelength wavelength division multiplexers, where the green structure represents the upper layer silicon nitride guide, and the white structure represents the lower layer silicon nitride guide. Each interlayer coupler uses an adiabatic gradual tapered structure, with the tip of one layer corresponding to the tail of the other layer. When the waveguide continuously narrows, an optical field gradually loses confinement, a super mode is formed between the two layer waveguides and gradually transitions to another layer waveguide, and vice versa. The dual-layer waveguide ensures a certain distance to avoid interlayer crosstalk, and evanescent wave coupling efficiency is also taken into consideration.

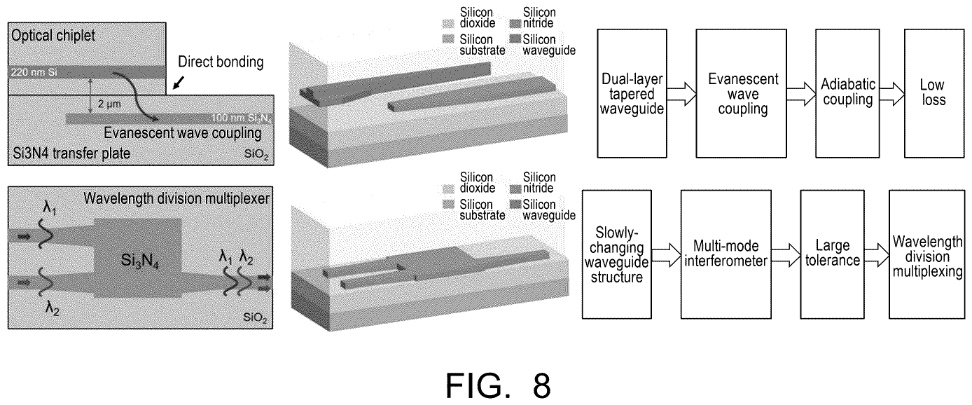

As shown in FIG. 8, in the embodiments of the disclosure, a silicon-silicon nitride coupler structure and a silicon nitride wavelength division multiplexer structure are adopted. Preferably, a thickness of a silicon waveguide in each chiplet is selected to be 220 nm, a thickness of a silicon nitride waveguide in the optical transfer plate is selected to be 100 nm, and a thickness of a silicon dioxide cladding layer above the silicon chiplet and silicon nitride transfer plate are both selected to be 2 μm. The chiplet is packaged to the transfer plate by using a flip-chip bonding method, and the silicon-silicon nitride coupler uses a vertically aligned adiabatic tapered structure to complete evanescent wave coupling, with a principle similar to the interlayer coupler. The silicon nitride wavelength division multiplexer uses an asymmetric multi-mode interference coupler structure, selects a common self-imaging point of two light of different wavelengths as a position of the beam combining waveguide, and completes wavelength division multiplexing.

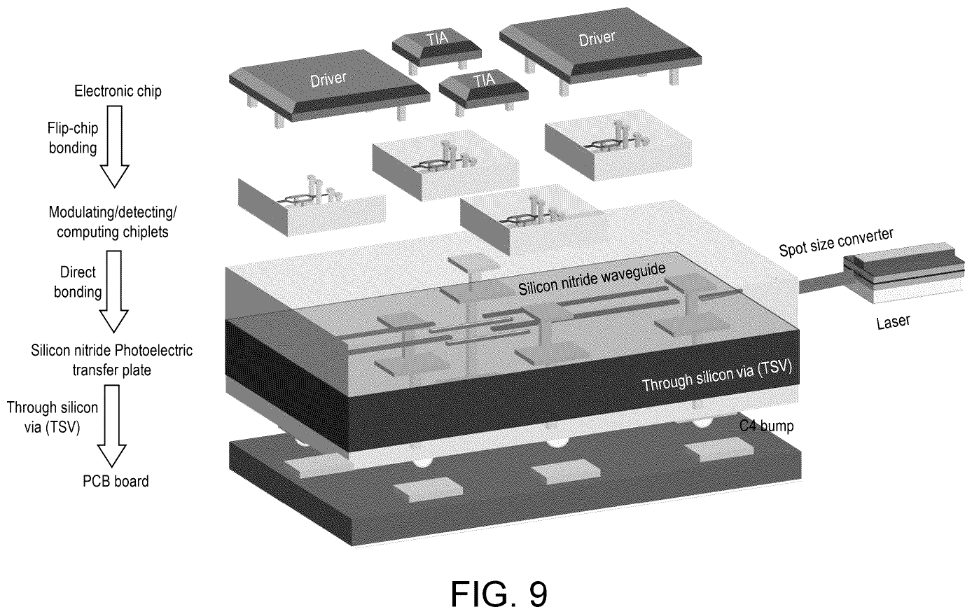

As shown in FIG. 9, in the embodiments of the disclosure, the optical chiplets, the electronic chip, and the optical transfer plate use three-dimensional packaging. The electronic chip is bonded onto an optical chip through flip-chip bonding to power the optical chiplets, then the optical chiplets are bonded onto the optical transfer plate through direct bonding, and finally, the optical transfer plate is packaged with a PCB board through a TSV process to form a system. An external laser uses methods such as prism/microlens coupling, fiber coupling, etc. to implement low-loss end-surface coupling.

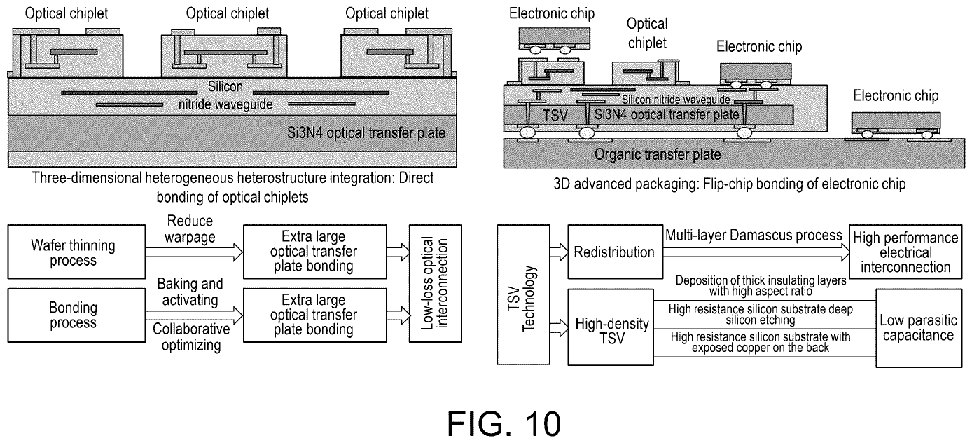

As shown in FIG. 10, in the embodiments of the disclosure, the chiplets are directly bonded to the transfer plate, and the multi-chiplet optical matrix computing system and peripheral circuits use through-silicon via interconnection. Before bonding, a wafer of the chiplets needs to undergo a backside thinning process to reduce warpage. To implement high-performance electrical interconnection, a redistribution layer needs to be made on the optical transfer plate, with the purpose of fanning out high-density electrodes to an edge blank region to avoid damaging the optical structure on the transfer plate when making through-silicon vias. The electrodes are then connected to the back surface of the optical transfer plate to be connected to the PCB board through the TSV process.

A person having ordinary skill in the art should be able to easily understand that the above description is only preferred embodiments of the disclosure and is not intended to limit the disclosure. Any modifications, equivalent replacements, and modifications made without departing from the spirit and principles of the disclosure should fall within the protection scope of the disclosure.

What is claimed is:

1. A multi-chiplet optical matrix computing architecture, decomposing a large chip into a plurality of small chiplets through matrix blocking and separation of active modules and passive modules on an optical computing architecture, and comprising:
n modulator array chiplets;
m×n optical matrix computing chiplets;
m detector array chiplets; and
an optical transfer plate for chiplet interconnection,
wherein the matrix blocking decomposes the large chip into arrays and matrices according to a functional scale and a manufacturing process,
wherein the active modules comprise the modulator array chiplets and the detector array chiplets,
wherein the passive modules comprise the optical matrix computing chiplets, each modulator array chiplet comprises q parallel modulators,
wherein each detector array chiplet comprises p parallel detectors, each optical matrix computing chiplet provides a p×q matrix computing sub-function comprising q input ports and p output ports,
wherein input light passes through the n modulator array chiplets, is modulated into q-path signal light in each modulator array chiplet, and forms n channel q-dimensional input vectors Xⱼ after passing through the n modulator array chiplets, each channel q-dimensional input vector Xⱼ is replicated m times through l:m beam splitting, the n channel q-dimensional input vectors Xⱼ form m×n q-dimensional vectors after replication and are correspondingly input into the m×n optical matrix computing chiplets separately and multiplied with corresponding p×q matrices Aᵢⱼ to obtain m×n p-dimensional vectors, light from n channels is multiplexed through n-channel multiplexing, m p-dimensional output vectors Yᵢ are obtained and provided to the m detector array chiplets for sequential detection to obtain a multi-chiplet optical matrix computing result,
wherein the light from the n channels comprises orthogonal channels of different wavelengths, orthogonal channels of different polarizations, orthogonal channels of different modes, orthogonal channels of other optical wave dimensions, and orthogonal channels of different dimensional combinations,
wherein i=1, 2, . . . , and m, and j=1, 2, . . . , and n.

2. The multi-chiplet optical matrix computing architecture according to claim 1, wherein for large-scale matrix-vector multiplication computation Y=AX, X is an input N-dimensional vector, Y is an output N-dimensional vector, A is an M×N matrix, the matrix blocking concept is adopted, the M×N matrix A is decomposed into m×n p×q matrices Aᵢⱼ, where M=m×p and N=n×q, the input N-dimensional vector X is decomposed into n channel q-dimensional input vectors Xⱼ, the output M-dimensional vector Y is decomposed into m p-dimensional output vectors Yᵢ, that is:
$$A = ( \begin{matrix}{a}_{11} & {a}_{12} & … & {a}_{1 q} & … & {a}_{1 N} \\ {a}_{21} & {a}_{22} & … & {a}_{2 q} & … & {a}_{2 N} \\ ⋮ & ⋮ & ⋱ & ⋮ & ⋱ & ⋮ \\ {a}_{p 1} & {a}_{p 2} & … & {a}_{pq} & … & {a}_{pN} \\ ⋮ & ⋮ & ⋱ & ⋮ & ⋱ & ⋮ \\ {a}_{M 1} & {a}_{M 2} & … & {a}_{Mq} & … & {a}_{MN}\end{matrix} ) = ( \begin{matrix}{A}_{11} & {A}_{12} & … & {A}_{1 n} \\ {A}_{21} & {A}_{22} & … & {A}_{2 n} \\ ⋮ & ⋮ & ⋱ & ⋮ \\ {A}_{m 1} & {A}_{m 2} & … & {A}_{mn}\end{matrix} ) ,$$
$$X = ( \begin{matrix}{X}_{1} \\ {X}_{2} \\ ⋮ \\ {X}_{n}\end{matrix} ) , Y = ( \begin{matrix}{Y}_{1} \\ {Y}_{2} \\ ⋮ \\ {Y}_{m}\end{matrix} ) ,$$
where Aᵢⱼ is the decomposed p×q matrix,
$${A}_{11} = ( \begin{matrix}{a}_{11} & {a}_{12} & … & {a}_{1 q} \\ {a}_{21} & {a}_{22} & … & {a}_{2 q} \\ ⋮ & ⋮ & ⋱ & ⋮ \\ {a}_{p 1} & {a}_{p 2} & … & {a}_{pq}\end{matrix} ) ,$$
and a result of the large-scale matrix-vector multiplication computation Y=AX is expressed as:
$$Y = AX = ( \begin{matrix}{A}_{11} {X}_{1} + {A}_{12} {X}_{2} + … + {A}_{1 n} {X}_{n} \\ {A}_{21} {X}_{1} + {A}_{22} {X}_{2} + … + {A}_{2 n} {X}_{n} \\ ⋮ \\ {A}_{m 1} {X}_{1} + {A}_{m 2} {X}_{2} + … + {A}_{m n} {X}_{n}\end{matrix} ) = ( \begin{matrix}{Y}_{1} \\ {Y}_{2} \\ ⋮ \\ {Y}_{m}\end{matrix} ) ,$$
$$where {Y}_{1} = {A}_{11} {X}_{1} = ( \begin{matrix}{a}_{11} & {a}_{12} & … & {a}_{1 q} \\ {a}_{21} & {a}_{22} & … & {a}_{2 q} \\ ⋮ & ⋮ & ⋱ & ⋮ \\ {a}_{p 1} & {a}_{p 2} & … & {a}_{pq}\end{matrix} ) ( \begin{matrix}{x}_{1} \\ {x}_{2} \\ ⋮ \\ {x}_{q}\end{matrix} ) ,$$
and Y₂, Y₃, . . . , Yₘ are similar.

3. The multi-chiplet optical matrix computing architecture according to claim 1, wherein each of the modulator array chiplets comprises q parallel modulators, and the modulators comprise micro-ring modulators, micro-disk modulators, photonic crystal micro-cavity modulators, Mach-Zehnder modulators, electro-absorption modulators, modulators based on two-dimensional materials, or micro-ring and Mach-Zehnder combination structure modulators.

4. The multi-chiplet optical matrix computing architecture according to claim 1, wherein each of the detector array chiplets comprises p parallel detectors, and the detectors comprise germanium-silicon photodetectors, avalanche detectors, III-V group-based photodetectors, or detectors based on two-dimensional materials.

5. The multi-chiplet optical matrix computing architecture according to claim 1, wherein the optical matrix computing chiplets comprise cascaded Mach-Zehnder interferometers, micro-ring resonator arrays, phase-change material synapse arrays, or on-chip two-dimensional planar diffraction structures,
wherein a network type adopted by the cascaded Mach-Zehnder interferometers is a triangular network, a rectangular network, or a non-universal Fast Fourier Transform (FFT) network.

6. The multi-chiplet optical matrix computing architecture according to claim 1, wherein the optical transfer plate comprises a single-layer structure or a multi-layer structure, each layer comprises a waveguide array, an interlayer coupler, a l:m beam splitter, and an n-channel multiplexer, and a multi-layer waveguide is adopted to reduce waveguide crossing of chiplet interconnection,
wherein the interlayer coupler uses an evanescent wave coupler to implement coupling between a chiplet layer and an optical transfer plate layer and coupling between different optical transfer plate layers,
wherein the l:m beam splitter uses a micro-nano structure beam splitter comprising a multi-mode interference coupler for routing the signal light to each optical matrix computing chiplet,
wherein the n-channel multiplexer is used to multiplex and add computation results from each optical matrix computing chiplet and comprises a wavelength division multiplexer, a polarization multiplexer, a mode multiplexer, or a multi-dimensional multiplexer integrating wavelength, polarization, and mode.

7. The multi-chiplet optical matrix computing architecture according to claim 1, wherein the input light enters the n modulator array chiplets or the optical transfer plate through coupling, and a coupling method is end-surface coupling or vertical coupling.

8. The multi-chiplet optical matrix computing architecture according to claim 1, wherein a material platform of the modulator array chiplets is silicon, thin-film lithium niobate, electro-optic polymers, III-V group, two-dimensional materials, ferroelectric thin films, and piezoelectric thin films,
wherein a material platform of the optical matrix computing chiplets comprises silicon, silicon nitride, silicon dioxide, and thin-film lithium niobate,
wherein a material platform of the detector array chiplets comprises germanium epitaxially grown on silicon, III-V group, and two-dimensional materials,
wherein a material platform of the optical transfer plate comprises silicon nitride, silicon dioxide, and organic polymer materials.

9. The multi-chiplet optical matrix computing architecture according to claim 1, further comprising a peripheral circuit module for driving and controlling a multi-chiplet system,
wherein the peripheral circuit module comprises a high-speed signal loading circuit and a low-speed multi-channel control power source,
wherein the high-speed signal loading circuit comprises a high-speed field programmable gate array (FPGA), a high-speed digital-to-analog converter (DAC), a high-speed analog-to-digital converter (ADC), a high-speed driver amplifier (Driver), and a high-speed trans-impedance amplifier (TIA),
wherein the high-speed FPGA is used to provide a digital electrical signal corresponding to data to be computed and processed, through the high-speed DAC, an analog electrical signal is obtained and is then driven and loaded to the modulator after being amplified to an appropriate level by the high-speed Driver, after optical matrix computing, a detected electrical signal is obtained through the detector and is appropriately amplified together with the high-speed TIA, a digital electrical signal is obtained through the high-speed ADC and is finally provided to the high-speed FPGA or a computer for processing,
wherein the low-speed multi-channel control power source comprises a microprocessor or a low-speed FPGA, a low-speed multi-channel DAC, and a low-speed power amplifier and is used to control and adjust various phase shifters in optical chips and chiplets, so as to flexibly configure coefficients in a matrix of optical matrix computing.

10. The multi-chiplet optical matrix computing architecture according to claim 9, wherein the modulator array chiplets, the detector array chiplets, the optical matrix computing chiplets, and the optical transfer plate are integrated through a direct bonding method,
wherein a packaging method between the peripheral circuit modules and the optical transfer plate is 2.5D or 3D advanced packaging, 2.5D packaging is implemented by wire bonding an electronic chip and the optical transfer plate on a ceramic transfer plate or a printed circuit board (PCB), or 3D advanced packaging is implemented by directly flip-chip bonding the electronic chip combined with through-silicon via technology.
